(19) United States
(12) Patent Application Publication
(10) Pub. No.: US 2014/0103176 A1
(43) Pub. Date: Apr. 17, 2014

(54) BACKPLANE

(71) Applicant: Gang Yu, Shenzhen City (CN)

(72) Inventor: Gang Yu, Shenzhen City (CN)

(73) Assignee: Shenzhen China Star Optoelectronics Technology Co., Ltd, Shenzhen, Guangdong (CN)

(21) Appl. No.: 13/702,093

(22) PCT Filed: Oct. 9, 2012
(86) PCT No.: PCT/CN12/82598

§ 371 Date: Dec. 5, 2012

(30) Foreign Application Priority Data
Sep. 7, 2012 (CN) 201210330306.4

(51) Int. Cl. F16M 13/02

(52) U.S. Cl. CPC F16M 13/02
USPC 248/222.14; 248/225.21

(57) ABSTRACT

The present invention provides a backplane, which includes a main body and a plurality of wall-mounting pieces mounted to the main body. Each of the wall-mounting pieces forms a first arc opening. The first arc opening is engageable with a first bolt to mount the backplane to the wall-mounting rack. With the backplane being of a wall-mounting structure that is arranged to be directly suspended on a head of a bolt or a suspension hook structure, the backplane can be suspended on a wall-mounting rack with the bolt or the suspension hook structure, making the use easy. The wall-mounting structure is easy to manufacture, is easy to use, shortens the processing time of the backplane, and lower down manufacture cost.

### BACKGROUND OF THE INVENTION

1. Field of the Invention

The present invention relates to the field of liquid crystal display device, and in particular to a wall-mounting arrangement of backplane of liquid crystal module.

2. The Related Arts

Liquid crystal display (LCD) has a variety of advantages, such as thin device body, low power consumption, and being free of radiation, and is thus widely used. Most of the LCDs that are currently available in the market are backlighting LCDs, which comprise a liquid crystal panel and a backlight module. The operation principle of the liquid crystal panel is that liquid crystal molecules are interposed between two parallel glass substrates and a plurality of vertical and horizontal fine electrical wires are arranged between the two glass substrates, whereby the liquid crystal molecules are controlled to change direction by application of electricity in order to refract light emitting from the backlight module for generating images. Since the liquid crystal panel itself does not emit light, light must be provided by the backlight module in order to normally display images. Thus, the backlight module is one of the key components of an LCD. The backlight module can be classified in two types, namely side-edge backlight module and direct backlight module, according to the position where light gets incident. The direct backlight module comprises a light source, such as a cold cathode fluorescent lamp (CCFL) or a light-emitting diode (LED), which is arranged at the back side of the liquid crystal panel to form a planar light source that directly provides lighting to the liquid crystal panel. The side-edge backlight module comprises a backlight source of LED light bar arranged at an edge of a backplane to be located rearward of one side of the liquid crystal panel. The LED light bar emits light that enters a light guide plate (LGP) through a light incident face of the light guide plate and is projected out through a light emergence face of the light guide plate, after being reflected and diffused, to thereby transmit through an optic film assembly and form a planar light source for the liquid crystal panel.

In the arrangement of the conventional liquid crystal display module, the liquid crystal display is mounted on a wall through wall-mounting means. The wall-mounting arrangement is often threaded pegs 200 riveted to a back frame 100. The threaded pegs 200 have internal threads, whereby through mating engagement of the internal threads with bolts, wall mounting can be achieved. However, such threaded pegs 200 are manufactured through milling, which is of high cost. Further, riveting also imposes a severe influence on the processing time of the back frame thereby increasing the cost of the back frame.

### SUMMARY OF THE INVENTION

An object of the present invention is to provide a backplane, which comprises a wall-mounting structure that is easy to manufacture and is easy to use so as to shorten the processing time of the backplane and lower down the manufacture cost.

To achieve the object, the present invention provides a backplane, which comprises a main body and a plurality of wall-mounting pieces mounted to the main body. Each of the wall-mounting pieces forms a first arc opening. The first arc opening is engageable with a first bolt to mount the backplane to a wall-mounting rack.

The wall-mounting pieces are of a “Ω” shape, which comprises two positioning sections and a wall-mounting mating section arranged between the two positioning sections and connected to the two positioning sections.

Each of the positioning sections forms a positioning hole. The main body forms mounting holes corresponding to the positioning holes. Second bolts are respectively received through the positioning holes to securely fasten the positioning sections to the mounting holes, thereby securely mounting the wall-mounting piece to the main body.

The first arc opening is formed in an edge corner of the wall-mounting mating section.

The wall-mounting pieces are of a number of 4.

The present invention also provides a backplane, which comprises a main body and a plurality of wall-mounting pieces mounted to the main body, each of the wall-mounting pieces forming a first arc opening, the first arc opening being engageable with a first bolt to mount the backplane to a wall-mounting rack;

wherein the wall-mounting pieces are of a “Ω” shape, which comprises two positioning sections and a wall-mounting mating section arranged between the two positioning sections and connected to the two positioning sections;

wherein each of the positioning sections forms a positioning hole, the main body forming mounting holes corresponding to the positioning holes, second bolts being respectively received through the positioning holes to securely fasten the positioning sections to the mounting holes, thereby securely mounting the wall-mounting piece to the main body;

wherein the first arc opening is formed in an edge corner of the wall-mounting mating section; and

wherein the wall-mounting pieces are of a number of 4.

The present invention further provides a backplane, which comprises a main body and a plurality of wall-mounting pieces mounted to the main body. The wall-mounting pieces are of an arch shape, which forms a through hole. A wall-mounting rack for mounting the backplane comprises a suspension hook structure corresponding to each of the wall-mounting pieces. The through holes are engageable with the suspension hooks to mount the backplane to the wall-mounting rack.

Each of the wall-mounting pieces comprises a top section and two shoulder sections connected to the top section with a through holes formed below the top section.

The wall-mounting pieces and the main body are integrally formed.

The wall-mounting piece further comprises a sidewall. The sidewall, the top section, and the two shoulder sections collectively form a projection of an inverted “U” shape. The top section forms a second arc opening. The second arc opening is engageable with the suspension hook to mount the backplane to the wall-mounting rack.

The wall-mounting pieces are of a number of 4.

The efficacy of the present invention is that the present invention provides a backplane, wherein the backplane comprises a wall-mounting structure that is arranged to be directly suspended on a head of a bolt or a suspension hook structure so that the backplane can be suspended on a wall-mounting rack with the bolt or the suspension hook structure, making the use easy. The wall-mounting structure is easy to manufacture, is easy to use, shortens the processing time of the backplane, and lower down manufacture cost.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, of the present invention will be apparent from the following detailed description of an embodiment of the present invention, with reference to the attached drawings. In the drawings:

FIG. 1 is a schematic showing conventional wall-mounting structure of backplane;

FIG. 2 is a perspective view showing a wall-mounting piece of a backplane according to the present invention;

FIG. 3 is a schematic view illustrating an operation of installing the wall-mounting piece of FIG. 2;

FIG. 4 is a schematic view showing the structure of another embodiment of a backplane and a wall-mounting piece thereof according to the present invention; and

FIG. 5 is a schematic view illustrating an operation of installing the wall-mounting piece of FIG. 4.

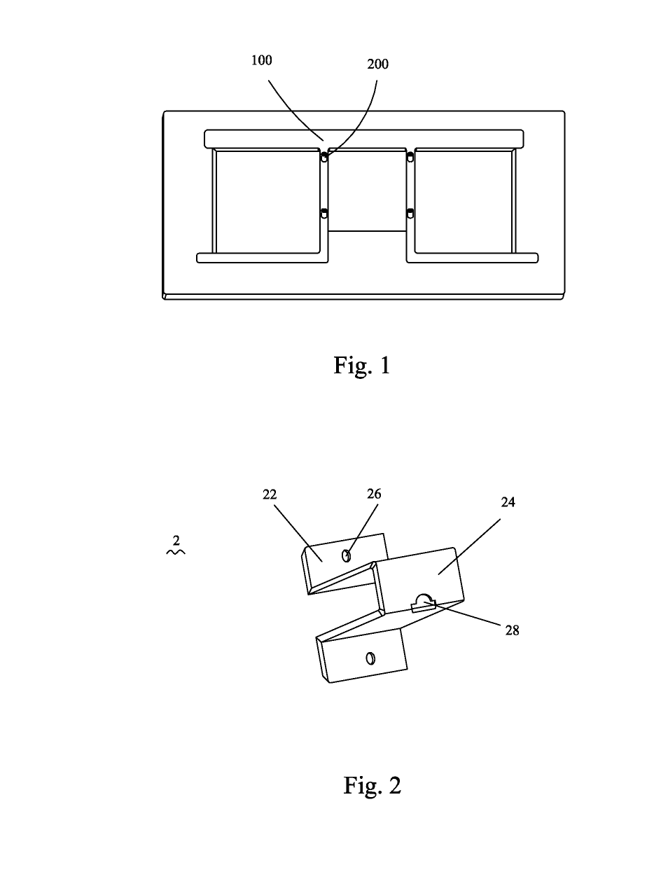

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

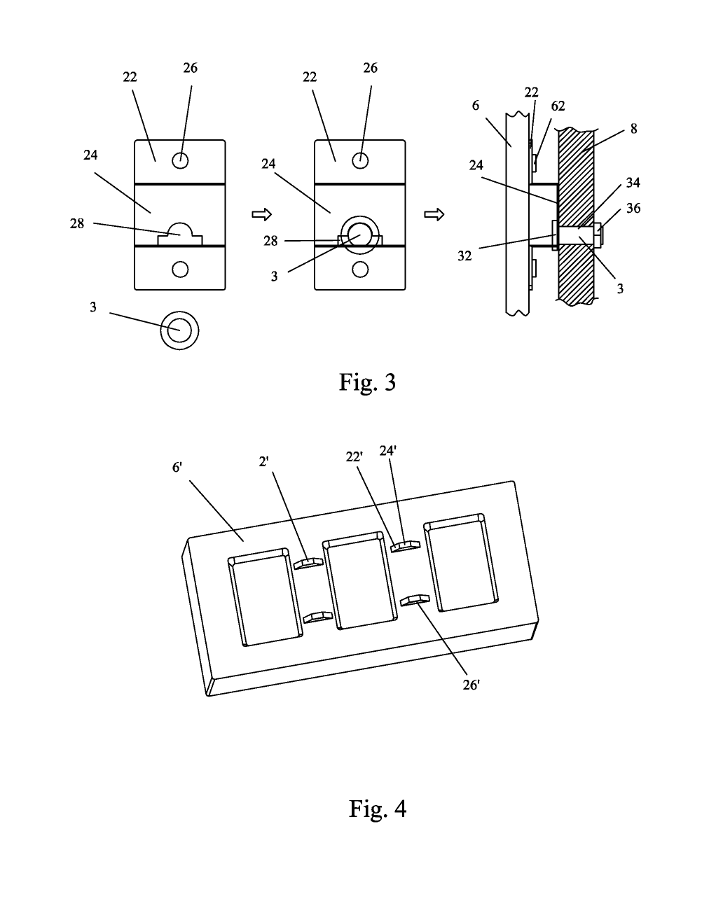

Referring to FIGS. 2 and 3, the present invention provides a backplane, which comprises a main body 6 and a plurality of wall-mounting pieces 2 mounted to the main body 6. Each of the wall-mounting pieces 2 forms a first arc opening 28, whereby the first arc opening 28 is engageable with a first bolt 3 to mount the backplane to a wall-mounting rack 8.

The wall-mounting pieces 2 are of a “Ω” shape, which comprises two positioning sections 22 and a wall-mounting mating section 24 arranged between the two positioning sections 22 and connected to the two positioning sections 22. Preferably, the positioning sections 22 are perpendicularly connected to the wall-mounting mating section 24.

Each of the positioning sections 22 forms a positioning hole 26. The main body 6 forms mounting holes (not labeled) respectively corresponding to the positioning holes 26. Second bolts 62 are respectively received through the positioning holes 26 to securely fasten the positioning sections 22 to the mounting holes, thereby securely mounting the wall-mounting piece 2 to the main body 6.

The first arc opening 28 is formed in the middle of an edge corner of the wall-mounting mating section 24. The wall-mounting rack 8 forms a bolt hole (not labeled) corresponding to the first arc opening 28. With a head 32 of the first bolt 3 engaging the first arc opening 28, the backplane is mounted to the wall-mounting rack 8.

In the instant preferred embodiment, the wall-mounting pieces 2 are of a number of 4 and the four wall-mounting pieces 2 are of a rectangular configuration.

Referring to FIG. 3, to install, the first bolt 3 is fit sideways into the first arc opening 28 and mates a curved wall of the first arc opening 28. A threaded rod 34 of the first bolt 3 is then put through the bolt hole of the wall-mounting rack 62 and is tightened with a nut 36 to thereby mount the backplane to the wall-mounting rack 8.

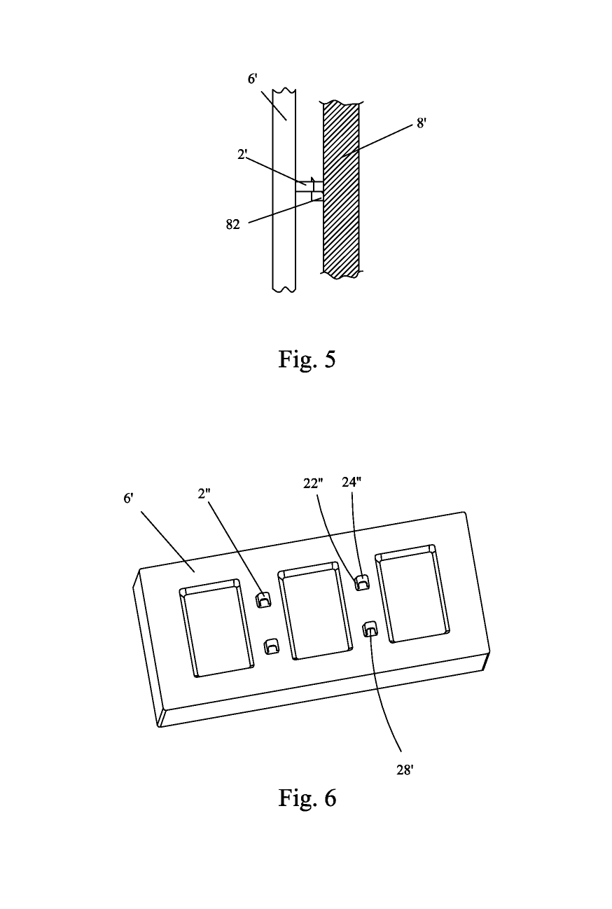

Referring to FIGS. 4 and 5, the present invention also provides a backplane, which comprises a main body 6′ and a plurality of wall-mounting pieces 2′ mounted to the main body 6′. The wall-mounting pieces 2′ are of an arch shape, which forms a through hole 26′. A wall-mounting rack 8′ for mounting the backplane comprises a suspension hook structure 82 corresponding each of the wall-mounting pieces 2′. The through holes 26′ engage the suspension hooks 82 to mount the backplane to the wall-mounting rack 8′.

Each of the wall-mounting pieces 2′ comprises a top section 24′ and two shoulder sections 22′ connected to the top section 24′ with a through holes 26′ formed below the top section 24′.

The wall-mounting pieces 2′ are integrally formed with the main body 6′, but not limited thereto, and can be alternatively adhesively bonded to the main body 6′. In the instant preferred embodiment, the wall-mounting pieces 2′ are of a number of 4 and are in the form of rectangle mounted on the main body 6′.

To install, the through holes 26′ of the backplane are directly fit to the suspension hook structures 82 of the wall-mounting rack 8′ to mount the backplane to the wall-mounting rack 8′ thereby achieving wall mounting.

Referring to FIG. 6, another preferred embodiment, as an alterative solution, is an improvement made on the basis of the previous embodiment. Each wall-mounting piece 2″ further comprises a sidewall (not labeled). The sidewall, the top section 24″, and the two shoulder sections 22″ collectively define a projection of an inverted “U” shape. The top section 22″ forms a second arc opening 28′. The second arc opening 28′ is engageable with a suspension hook structure to mount the backplane to the wall-mounting rack.

To install, the second arc opening 28′ of the backplane is directly fit to the suspension hook structure of the wall-mounting rack to mount the backplane to the wall-mounting rack thereby achieving wall mounting.

In summary, the present invention provides a backplane, wherein the backplane comprises a wall-mounting structure that is arranged to be directly suspended on a head of a bolt or a suspension hook structure so that the backplane can be suspended on a wall-mounting rack with the bolt or the suspension hook structure, making the use easy. The wall-mounting structure is easy to manufacture, is easy to use, shortens the processing time of the backplane, and lower down manufacture cost.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A backplane, comprising a main body and a plurality of wall-mounting pieces mounted to the main body, each of the wall-mounting pieces forming a first arc opening, the first arc opening being engageable with a first bolt to mount the backplane to a wall-mounting rack.

2. The backplane as claimed in claim 1, wherein the wall-mounting pieces are of a “Ω” shape, which comprises two positioning sections and a wall-mounting mating section arranged between the two positioning sections and connected to the two positioning sections.

3. The backplane as claimed in claim 2, wherein each of the positioning sections forms a positioning hole, the main body forming mounting holes corresponding to the positioning holes, second bolts being respectively received through the positioning holes to securely fasten the positioning sections to the mounting holes, thereby securely mounting the wall-mounting piece to the main body.

4. The backplane as claimed in claim 2, wherein the first arc opening is formed in an edge corner of the wall-mounting mating section.

5. The backplane as claimed in claim 1, wherein the wall-mounting pieces are of a number of 4.

6. A backplane, comprising a main body and a plurality of wall-mounting pieces mounted to the main body, each of the wall-mounting pieces forming a first arc opening, the first arc opening being engageable with a first bolt to mount the backplane to a wall-mounting rack;
wherein the wall-mounting pieces are of a “Ω” shape, which comprises two positioning sections and a wall-mounting mating section arranged between the two positioning sections and connected to the two positioning sections;
wherein each of the positioning sections forms a positioning hole, the main body forming mounting holes corresponding to the positioning holes, second bolts being respectively received through the positioning holes to securely fasten the positioning sections to the mounting holes, thereby securely mounting the wall-mounting piece to the main body;
wherein the first arc opening is formed in an edge corner of the wall-mounting mating section; and
wherein the wall-mounting pieces are of a number of 4.

7. A backplane, comprising a main body and a plurality of wall-mounting pieces mounted to the main body, the wall-mounting pieces being of an arch shape, which forms a through hole, a wall-mounting rack for mounting the backplane comprising a suspension hook structure corresponding to each of the wall-mounting pieces, the through holes being engageable with the suspension hooks to mount the backplane to the wall-mounting rack.

8. The backplane as claimed in claim 7, wherein each of the wall-mounting pieces comprises a top section and two shoulder sections connected to the top section with a through holes formed below the top section.

9. The backplane as claimed in claim 7, wherein the wall-mounting pieces and the main body are integrally formed.

10. The backplane as claimed in claim 9, wherein the wall-mounting piece further comprises a sidewall, the sidewall, the top section, and the two shoulder sections collectively forming a projection of an inverted “U” shape, the top section forming a second arc opening, the second arc opening being engageable with the suspension hook to mount the backplane to the wall-mounting rack.

11. The backplane as claimed in claim 7, wherein the wall-mounting pieces are of a number of 4.
